(19) United States
(12) Patent Application Publication
(10) Pub. No.: US 2021/0149640 A1
(43) Pub. Date: May 20, 2021

(54) AUTOMATICALLY PRODUCING MOBILE APPLICATION BINARIES

(71) Applicant: Salesforce.com, Inc., San Francisco, CA (US)

(72) Inventors: Claudia Brak, San Francisco, CA (US); Steven Bruce Holly, Laguna Niguel, CA (US); Brian Simmons, San Francisco, CA (US); Bing Ge, San Francisco, CA (US); Jayal Mehta, San Francisco, CA (US); Urvin Thakkar, San Francisco, CA (US)

(73) Assignee: Salesforce.com, Inc., San Francisco, CA (US)

(21) Appl. No.: 16/892,107

(22) Filed: Jun. 3, 2020

Related U.S. Application Data
(63) Continuation-in-part of application No. 16/688,504, filed on Nov. 19, 2019.

(51) Int. Cl. G06F 8/30; G06F 8/60

(52) U.S. Cl. CPC G06F 8/30; H04W 4/60; G06F 8/60

(57) ABSTRACT

A mobile application development environment may be maintained in association with a computing platform. A user interface associated with the mobile application development environment may be displayed on a device of a user of the computing platform. A request to produce a binary of a first mobile application may be processed. The binary of the first mobile application may be automatically produced.

### CROSS-REFERENCE TO RELATED APPLICATIONS

This patent document is a continuation-in-part of and claims priority to U.S. patent application Ser. No. 16/688,504 (Attorney Docket No. A4537US_SFDCP031) by Brak et al., titled “PRODUCING MOBILE APPLICATIONS”, filed Nov. 19, 2019. U.S. patent application Ser. No. 16/688,504 is hereby incorporated by reference in its entirety and for all purposes.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever

### FIELD OF TECHNOLOGY

This patent document relates generally mobile applications and more specifically to producing mobile applications.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks in association with production of mobile applications.

### BRIEF DESCRIPTION OF THE DRAWINGS

The included drawings are for illustrative purposes and serve only to provide examples of possible structures and operations for the disclosed inventive systems, apparatus, methods and computer program products for automatically producing mobile application binaries. These drawings in no way limit any changes in form and detail that may be made by one skilled in the art without departing from the spirit and scope of the disclosed implementations.

FIG. 1 shows a flowchart of an example of a method for automatically producing mobile application binaries, in accordance with some implementations.

FIG. 2 shows a block diagram of an example of a mobile application development environment, in accordance with some implementations.

FIG. 3 shows an example of a Graphical User Interface (GUI), in accordance with some implementations.

FIG. 4 shows a flowchart of an example of a method for producing mobile applications, performed in accordance with some implementations.

FIG. 5 shows an example of a GUI, in accordance with some implementations.

FIG. 6 shows an example of a GUI, in accordance with some implementations.

FIG. 7 shows an example of a GUI, in accordance with some implementations.

FIG. 8 shows an example of a GUI, in accordance with some implementations.

FIG. 9 shows an example of a GUI, in accordance with some implementations.

FIG. 10 shows an example of a GUI, in accordance with some implementations.

FIG. 11 shows an example of a GUI, in accordance with some implementations.

FIG. 12 shows a block diagram of an example of an environment that includes an on-demand database service configured in accordance with some implementations.

FIG. 13A shows a system diagram of an example of architectural components of an on-demand database service environment, configured in accordance with some implementations.

FIG. 13B shows a system diagram further illustrating an example of architectural components of an on-demand database service environment, in accordance with some implementations.

FIG. 14 illustrates one example of a computing device, configured in accordance with one or more embodiments.

### DETAILED DESCRIPTION

Some implementations of the disclosed systems, apparatus, methods and computer program products are configured for automatically producing mobile application binaries. As described in further detail below, such binary production and uploading techniques may be implemented alone or in association with any type of computing platform such as a Customer Relationship Management (CRM) Platform, a social networking system, any type of consumer or business software, etc. While CRM platforms (such as those provided by Salesforce.com®, inc.) are discussed herein as an example of such a computing platform, one having skill in the art can appreciate that the examples of computing platforms described herein may be substituted for any suitable computing platform such as those described above.

Existing platforms for mobile application production often run into problems with rules from mobile application providers such as the Apple® App Store or the Google® Play Store. Further, existing techniques may cause delays in the publication of mobile applications because mobile application providers' rejections are routed through a mobile application production platform rather than being sent directly to customers. By way of illustration, Wuthering Lights, a leading wholesaler in the candle industry, is implementing a new employee mobile application using an existing mobile application production platform. The existing mobile application production platform includes an automated framework for distributing produced mobile applications via the Apple® App Store. Unfortunately, the employee mobile application produced using the existing mobile application production platform does not comply with the current rules of Apple® App Store. As a result, publication of their mobile application is rejected by the Apple® App Store. Although Wuthering Lights is a sophisticated, multinational corporation with a close relationship to the Apple® App Store, Wuthering Lights cannot directly bring the employee mobile application into compliance with the Apple® App Store rules. Rather, Wuthering Lights must work through the existing mobile application production platform to bring the employee mobile application into compliance with the Apple® App Store rules, wasting time and delaying the publication of the Wuthering Lights employee mobile application.

By contrast, the disclosed techniques may streamline the automatic production of mobile application binaries uploaded to mobile application providers by separating the binary build and upload process from other interactions with mobile application providers such as beta or live reviews. As such, sophisticated customers may be given direct control of receiving and responding to rejections from mobile application providers. Returning to the above example, Wuthering Lights can use a mobile application production platform that employs the disclosed techniques to automatically produce a binary of the Wuthering Lights employee mobile application, which can be uploaded to the Apple® App Store by the mobile application production platform. Next steps in the mobile application distribution process (e.g. submitting mobile applications for reviews, uploading screenshots, generating a description of the mobile application, etc.) can be left to customers. Since the mobile application production platform need not play a role in the distribution of mobile applications to mobile application providers, Wuthering Lights can work directly with the Apple® App Store to bring the employee mobile application into compliance with the Apple® App Store rules.

Furthermore, some mobile application providers may issue erroneous or unreasonable rejections (e.g., by not reading test instructions correctly), which could lead a customer to falsely believe that a mobile application production platform is at fault for an erroneous rejection. Putting the customer in direct contact with mobile application providers mitigates this issue, allowing the customer to understand the correct details underlying rejections.

In some implementations, the techniques described in the above paragraphs may be applied in parallel with automated distribution techniques so that sophisticated customers may work directly with mobile application providers while less sophisticated customers may take advantage of automated distribution. By way of illustration, Eyre Books is a small Braille Book publisher. Jane, the Chief Executive Officer (CEO) of Eyre Books, may use the disclosed techniques to develop a new Eyre Books mobile application. Jane simply enters information about Eyre Books into a user interface. As described below, the mobile application may be automatically produced. In addition to binary production and uploading, the disclosed techniques may also be used for automated distribution of the Eyre Books mobile application to a mobile application provider, allowing employees and/or customers to download the application.

In some implementations, instead of uploading a binary to a mobile application provider, a mobile application production platform may solely produce a binary and provide the binary directly to a customer. As such, the mobile application production platform may avoid accessing the customer's account information for the mobile application provider. By way of illustration Mansfield Bank is a security conscious customer that does not want to give anyone (including a trusted mobile application production platform) access to its account information for any mobile application providers. Therefore, Mansfield Bank may use a mobile application production platform that implements the disclosed techniques to produce a binary of a Mansfield Bank mobile application. The mobile application production platform may provide the binary to Mansfield Bank, and Mansfield Bank may handle the rest of the mobile application distribution process, including uploading the binary of the Mansfield Bank mobile application to mobile application providers.

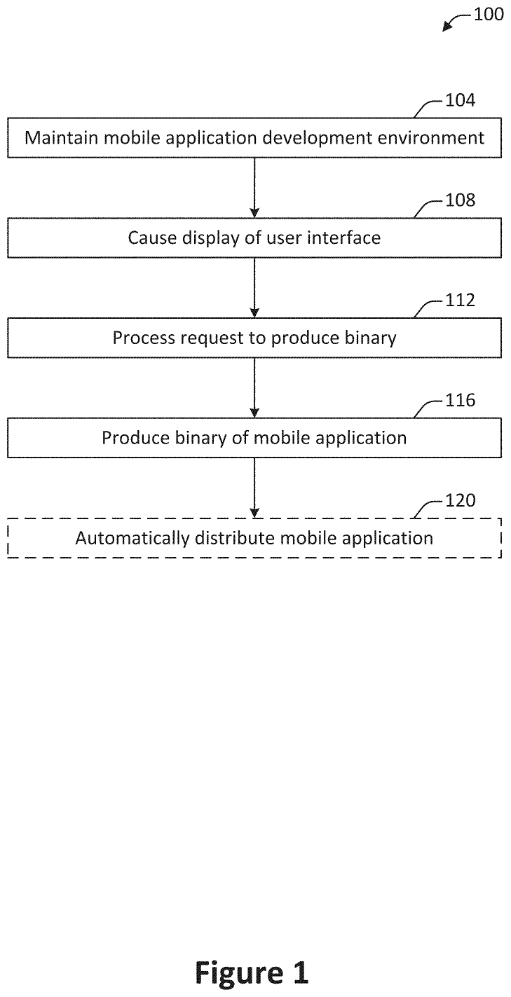

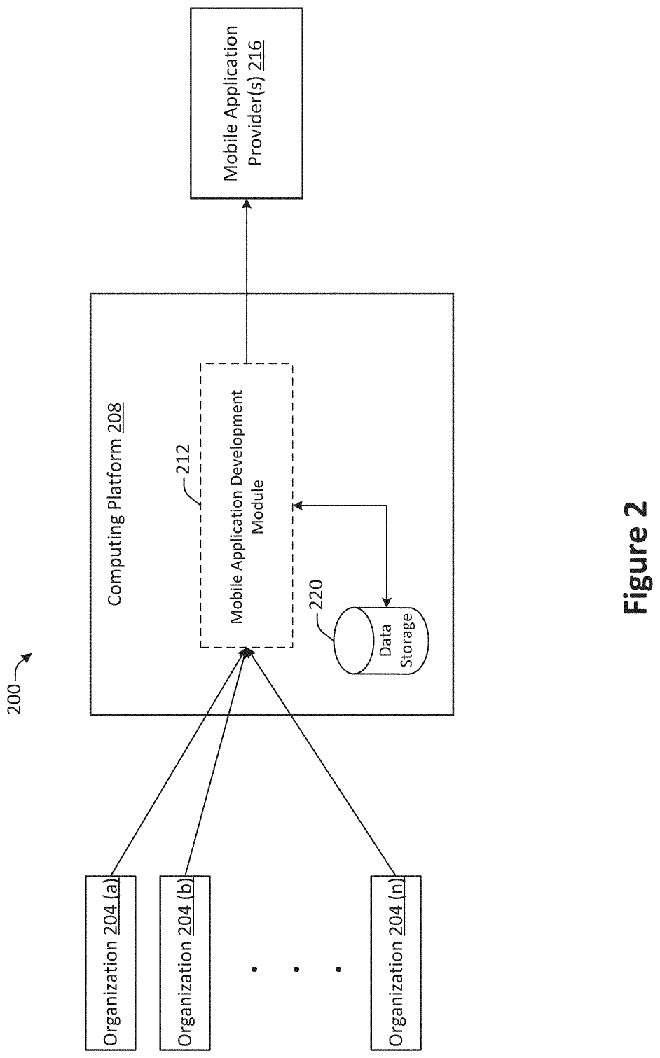

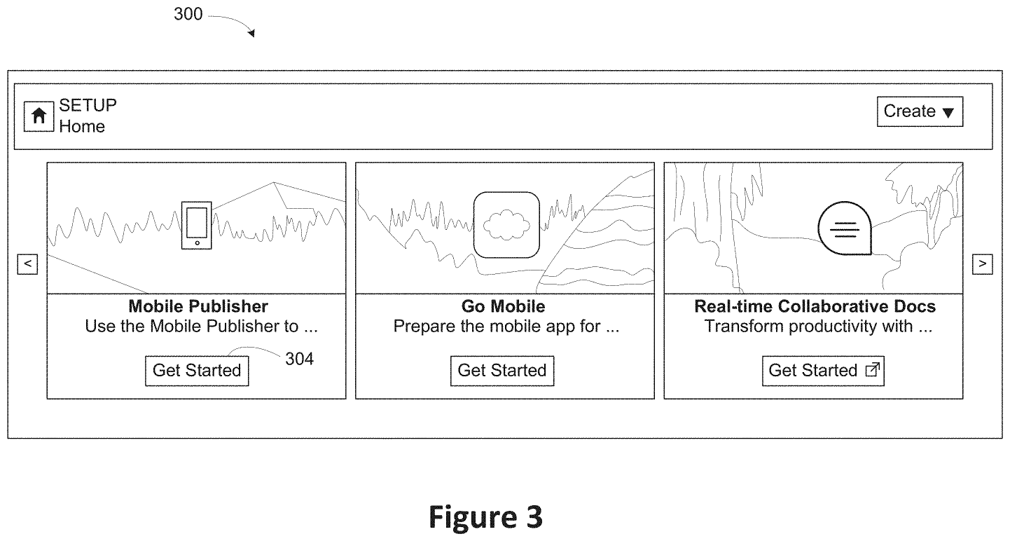

FIG. 1 shows a flowchart of an example of a method for automatically producing mobile application binaries, performed in accordance with some implementations. FIG. 1 is described in the context of FIGS. 2-3. FIG. 2 shows a block diagram of an example of a mobile application development environment, in accordance with some implementations.

FIG. 3 shows an example of a Graphical User Interface (GUI), in accordance with some implementations.

At 104 of FIG. 1, a mobile application development environment may be maintained.

In some implementations, the mobile application development environment may be maintained in association with a computing platform. By way of example, in mobile application development environment 200 of FIG. 2, organizations 204 (a)-(n) interact with computing platform 208. As discussed above, the computing platform 208 may be any type of computing platform and may have a variety of components such as a Customer Relationship Management (CRM) Platform, a social networking system, any type of consumer or business software, etc.

The computing platform 208 includes a mobile application development module 212, which may perform the automated application production and/or deployment techniques disclosed herein. For instance, in some implementations, users affiliated with the organizations 204 (a)-(n) may request production of mobile application binaries. The mobile application development module 212 may process such requests to generate such binaries. By way of example, Wuthering Lights may use a CRM platform, such as one provided by Salesforce.com®, to host a “community,” e.g., a branded space for its employees, customers, and partners to connect. The community may be designable and/or customizable by authorized users affiliated with Wuthering Lights. On behalf of Wuthering Lights, Catherine may request production of the Wuthering Lights employee mobile application binary. In response to Catherine's request, as discussed below, the mobile application development module 212 may access data stored in data storage 220 that defines the Wuthering Lights community such as information defining the content, design, and/or layout of the community. The mobile application development module 212 may use this information, as well as any other information entered by Catherine, to produce the binary of the Wuthering Lights employee mobile application. For example, the mobile application development module 212 may use data stored in any of the data storage 220 to convert a web version of the Wuthering Lights community into a binary of a mobile application such that the mobile application has the same or similar content, design, and/or layout as the web version of the Wuthering Lights community.

In some implementations, users affiliated with the organizations 204 (a)-(n) may provide metadata to the mobile application development module 212. By way of example, on behalf of Wuthering Lights, Catherine may provide metadata to the mobile application development module 212 to define a Wuthering Lights mobile application. As described below, the mobile application development module 212 may process metadata to automatically produce mobile applications for organizations 204 (a)-(n) providing the metadata. Returning to the above example, the mobile application development module 212 to may process the metadata provided by Catherine to produce a Wuthering Lights mobile application.

In some implementations, the mobile application development module 212 may automatically provide mobile applications to mobile application provider(s) 216, which may be any provider capable of providing mobile applications such as the Apple® App Store, the Android® app store, etc. Returning to the above example, the mobile application development module 212 may then provide the Wuthering Lights mobile application Apple® app store.

In some implementations, the mobile application development module 212 may automatically provide ongoing maintenance and updates to features of mobile applications. Such maintenance and updates may be automatically performed without requiring users to provide additional metadata. By way of example, as compatibility requirements (e.g., with iOS® or Android®) change, the mobile application development module 212 may automatically update existing mobile applications (e.g., mobile applications that were developed in the mobile application development environment 200) using existing metadata to bring the mobile applications into compliance with the changing compatibility requirements. In another example, in response to new security updates being issued, the mobile application development module 212 may automatically update existing mobile applications using existing metadata.

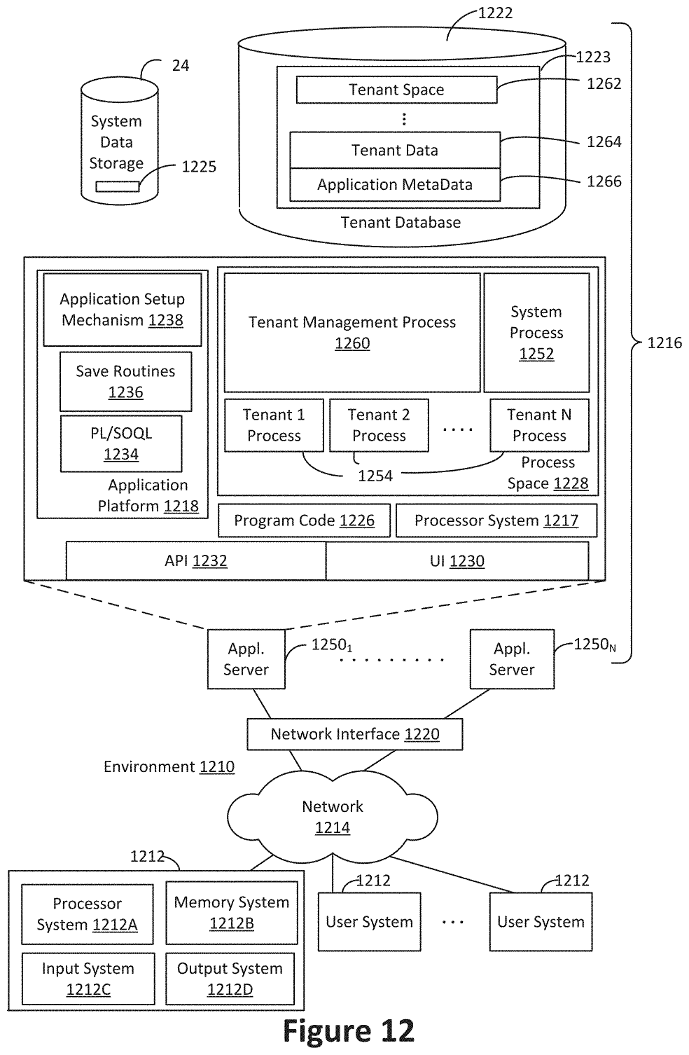

In some implementations, the computing platform 208 may be provided to the organizations 204 (a)-(n) via an on-demand computing environment, as discussed further below in the context of FIGS. 12-14. By way of example, the computing platform 208 may be provided to the organizations 204 (a)-(n) in a multi-tenant database system, as described below. Similar to tenant data storage 1222 of FIG. 12, data storage 220 of FIG. 2 may store data of the organizations 204 (a)-(n) in a multi-tenant architecture. The mobile application development module 212 may access the data storage 220 and use an organizations 204 (a)-(n) data when producing a mobile application. Similarly, the mobile application development module 212 may store metadata defining an organizations 204 (a)-(n) mobile application in the data storage 220. Returning to the above example, the mobile application development module 212 may access Wuthering Lights' data, which is stored in the data storage 220, when producing the Wuthering Lights mobile application. Once Catherine has provided metadata to define the Wuthering Lights mobile application, the mobile application development module 212 may cause the metadata to be stored in the data storage 220.

Returning to FIG. 1, in some implementations, at 108, a user interface may be caused to be displayed. Such a user interface may include input areas configured to receive input from a user to enter metadata to define a mobile application. By way of example, referring now to FIG. 3, Catherine may be using her computing device to interact with the computing platform 208 of FIG. 2. Catherine may navigate to home page 300 of FIG. 3. She may then click or tap “get started” button 304 to navigate to a mobile application development environment.

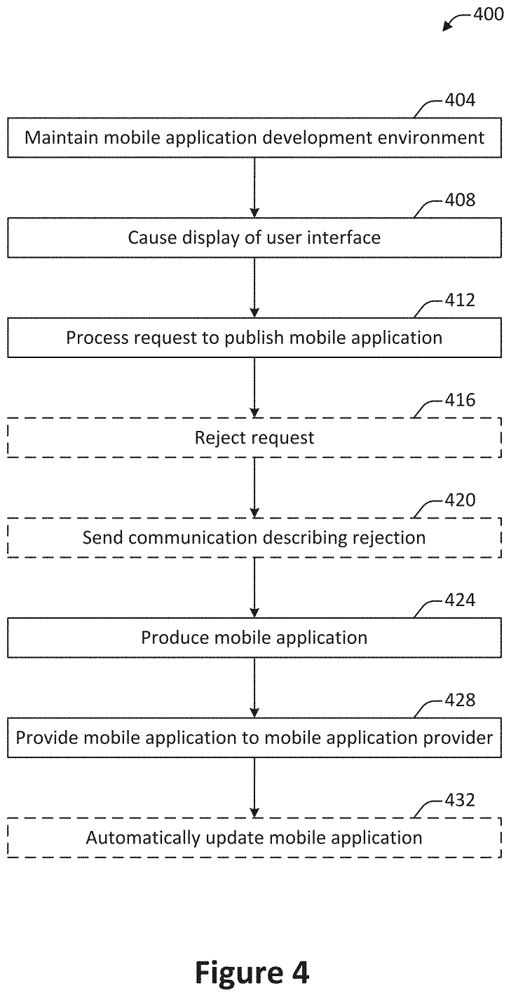

Such a mobile application development environment and techniques for using the mobile application development environment to produce and distribute mobile application is described further below in the context of method 400 of FIG. 4.

Returning to FIG. 1, at 112, a request to produce a binary of a first mobile application (e.g., the Wuthering Lights employee application) is processed. By way of example, using her computing device, Catherine may request to produce a binary of the Wuthering Lights employee application via the user interface of the mobile application development environment.

At 116 of FIG. 1, the binary of the first mobile application (e.g., the Wuthering Lights employee application) may be produced. In some implementations, the binary of the first mobile application may be produced in response to the request being processed at 112. By way of example, in response to Catherine's request, the mobile application development module 212 of FIG. 2 may use data stored in any of the data storage 220 to convert a web version of the Wuthering Lights community into a binary of a mobile application such that the mobile application has the same or similar content, design, and/or layout as the web version of the Wuthering Lights community, as described above.

As discussed above, in some implementations, after the binary production process is complete, the computing platform 208 of FIG. 2 may cease to play a role in production and distribution of the mobile application, allowing distribution to be handled solely by an organization affiliated with the mobile application. By way of example, as a sophisticated organization with its own relationship with mobile application providers, Wuthering Lights may only use the disclosed techniques for production of a mobile application binary of the Wuthering Lights Employee mobile application. After the Wuthering Lights Employee mobile application has been produced by the computing platform 208, Wuthering Lights may take over distribution of the Wuthering Lights Employee mobile application themselves. Accordingly, as described above, Wuthering Lights may deal directly with mobile application providers in bringing the Wuthering Lights Employee mobile application into accordance with the mobile application providers' rules. Furthermore, Wuthering Lights may change aspects of the Wuthering Lights Employee mobile application themselves (e.g. addressing content issues, such as deficient screenshots) and provide the Wuthering Lights Employee mobile application in new regions without having to return to the computing platform 208 to update the Wuthering Lights Employee mobile application.

Although binary building and uploading may be separated from other steps of the mobile application distribution process, a mobile application production platform may continuously provide customers with automated updates of mobile applications so customers have access to the latest versions of their mobile application. However, customers may then be given direct control of their mobile applications so that they can ensure that their mobile applications go live so their users can download the latest versions of their mobile applications.

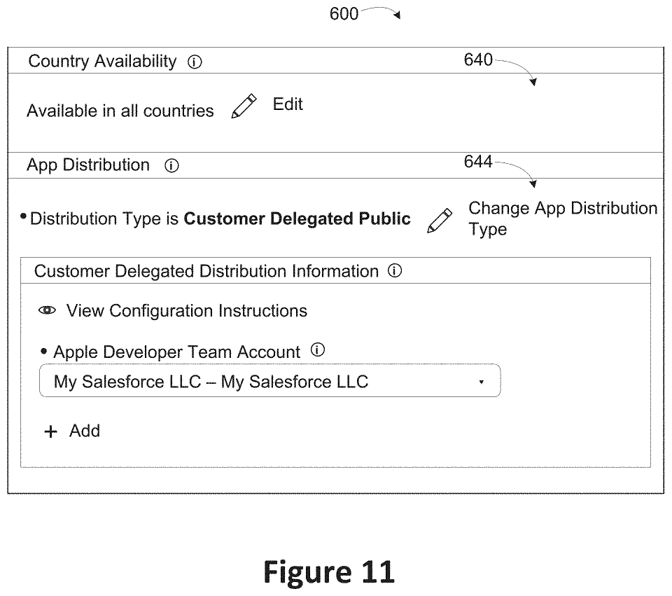

The disclosed mobile application production and distribution techniques may be applied differently depending on the type and/or needs of organizations that are implementing the disclosed techniques. For example, in some implementations, at 120 of FIG. 1, the mobile application (e.g., an Eyre Books mobile application) may be automatically distributed to one or more mobile application providers in accordance with distribution preferences of the organization (e.g., Eyre Books). By way of illustration, unlike sophisticated organizations like Wuthering Lights, as described above, less sophisticated organizations like Eyre Books may wish to use the disclosed techniques in parallel with automated distribution as discussed below. For instance, once mobile application binary production for the Eyre Books mobile application is complete, an authorized user of the computing platform affiliated with Eyre Books may select their distribution preferences by selecting a distribution type as described in further detail below in the context of FIG. 11. As described below, the Eyre Books may then be automatically distributed to mobile application provider(s) in accordance with Eyre Books' distribution preferences.

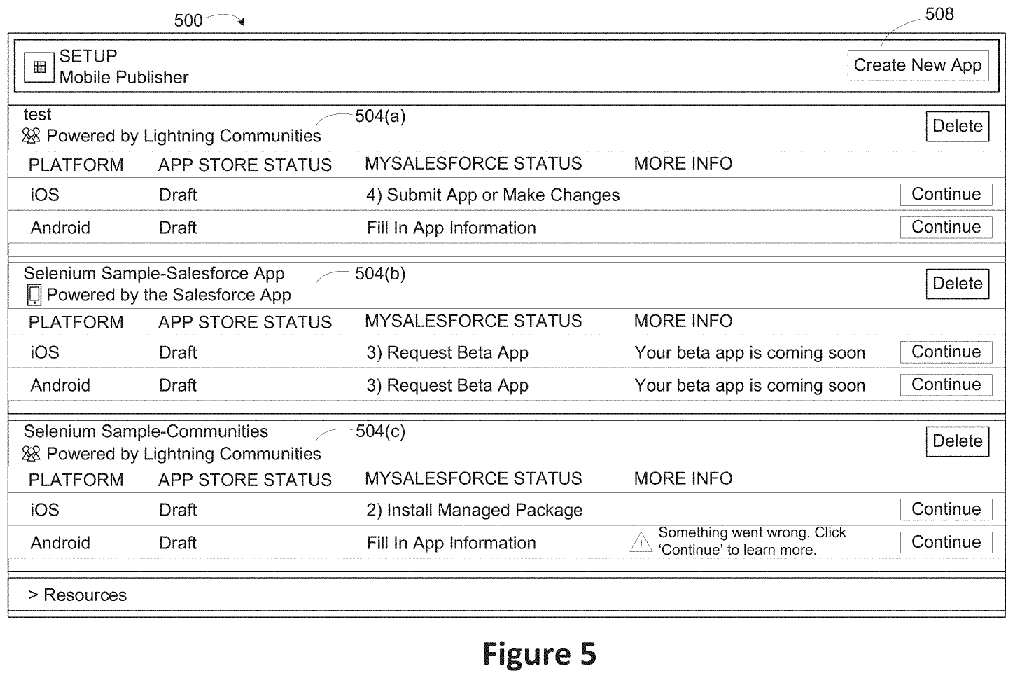

FIG. 4 shows a flowchart of an example of a method for producing mobile applications, performed in accordance with some implementations. FIG. 4 is discussed in the context of FIGS. 1-3 as well as FIGS. 5-11. FIGS. 5-11 show examples of GUIs, in accordance with some implementations.

**Inventors, the text highlighted in blue below has been repurposed from your earlier patent application. It provides support for the automated distribution framework and also provides important context. Since you looked it over when we did the previous patent application, it does not require careful review at this point.**

At 404 of FIG. 4, a mobile application development environment may be maintained. By way of example, the mobile application development environment 200 of FIG. 2 may be maintained as discussed above in the context of 104 of FIG. 1.

Returning to FIG. 4, in some implementations, at 408, a user interface may be caused to be displayed. Such a user interface may include input areas configured to receive input from a user to enter metadata to define a mobile application. As discussed above, such metadata may also be re-used in automated maintenance of and updates to the mobile application. By way of example, referring now to FIGS. 5-11, Catherine may be using her computing device to interact with the computing platform 208 of FIG. 2. Mobile application development environment home page 500 of FIG. 5 may be caused to be displayed on Catherine's computing device. From the home page 500, Catherine may delete or modify existing mobile applications 504 (a)-(c). From the home page 500, Catherine may also create a new mobile application by clicking or tapping “create new app” button 508. Once Catherine clicks or taps the create new app button 508, Catherine may be presented with a choice of mobile application types. Catherine may then choose a mobile application type from which the Wuthering Lights mobile application may be produced. Such types may encompass a wide range of potential mobile applications and may include any type of mobile application type provided by the computing platform 208 of FIG. 2. By way of example, Catherine may choose to make the Wuthering Lights mobile application based on a Salesforce® “Lightning Communities” mobile application type. Catherine may create and/or customize a web application using a framework provided by the computing platform 208. The mobile application development module 212 may process the web application in combination with Wuthering Light's branding information and/or additional metadata provided by Catherine, using the techniques disclosed herein to produce a downloadable Wuthering Lights mobile application.

One having skill in the art can appreciate that, in some implementations, the disclosed techniques may be practiced in combination with conventional coding. By way of illustration, returning to the example of the preceding paragraph, Catherine may hire Heathcliff to add additional customization to the Wuthering Lights mobile application using his application development skills.

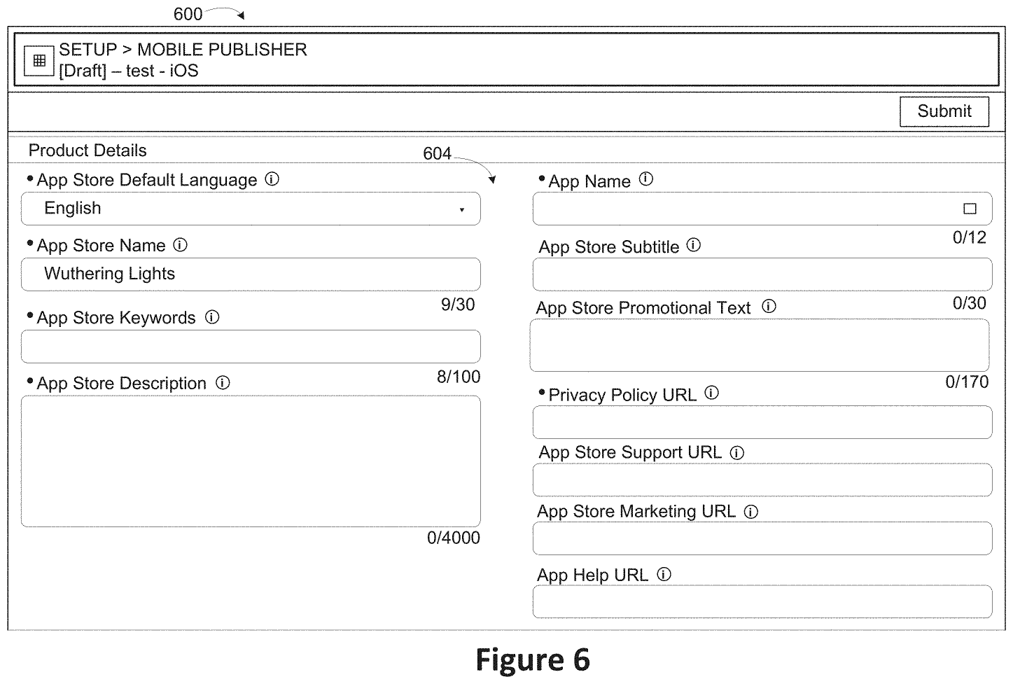

Once Catherine selects a mobile application type, mobile application metadata entry screen 600 of FIGS. 6-11 may be caused to be displayed on Catherine's computing device.

The types of metadata used to define a mobile application may include a range of material and may vary across implementations. One having skill in the art can appreciate that suitable material extends beyond the explanatory non-limiting examples discussed herein. For instance, the examples discussed in the context of FIGS. 6-11 relate to mobile applications developed to operate in iOS, which may be distributed via the Apple® App Store. One having skill in the art can appreciate that the disclosed techniques may be applied to produce mobile applications for any operating system (such as the Android® operating system) to be provided by any mobile application provider (such as the Google® Play store or any other Android® app store). The type of metadata used to define a mobile application may be changed to meet the requirements of any mobile application provider or operating system.

Returning to the above example, Catherine may enter metadata defining the Wuthering Lights mobile application in input areas of the mobile application metadata entry screen 600 of FIGS. 6-11. Catherine may enter basic product details such as the language of the Wuthering Lights mobile application, the name of the Wuthering Lights mobile application, a description of the Wuthering Lights mobile application, and other details into “product details” input area 604 of FIG. 6.

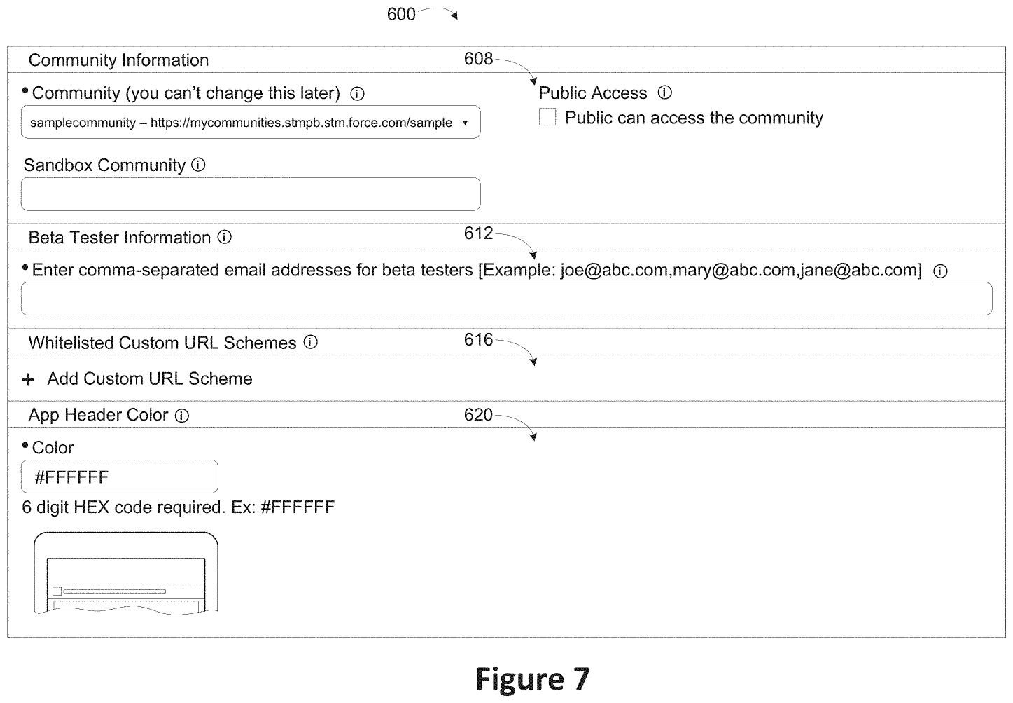

Continuing with the example of FIGS. 6-11, Catherine may enter details relating to community information in “community information” input area 608 of FIG. 7. As used herein, the term “community” generally refers to an online community accessible to certain members and/or customers of an organization. By way of example, Catherine may create a customer support community, a community dedicated to an upcoming Wuthering Lights event, etc.

Referring again to the example of the community information input area 608 of FIG. 7, as discussed above, Catherine may designate a particular Sandbox community where the beta version of the Wuthering Lights application may be made available. Similarly, Catherine may designate the community in which the Wuthering Lights mobile application will reside, and she may select whether the public can access the community.

In some implementations, Catherine may enter email addresses of beta testers who are approved to beta test the Wuthering Lights mobile application in “Beta Tester Information” input area 612 of FIG. 7.

Also or alternatively, Catherine may enter whitelisted custom URL schemes in “Whitelisted Custom URL Schemes” input area 616 of FIG. 7. By way of example, Catherine can whitelist any custom URL schemes that may be queried by the Wuthering Lights mobile application.

Continuing with the example depicted in FIG. 7, Catherine may choose the color of the Wuthering Lights mobile application header by entering a hexadecimal color code in “App Header Color” input area 620.

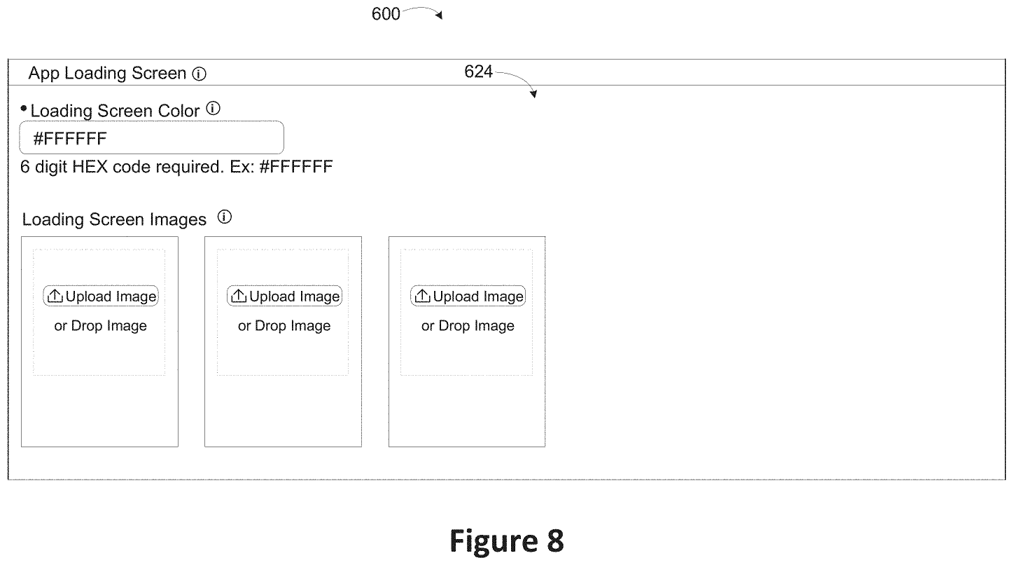

In some implementations, Catherine may enter details relating to the Wuthering Lights mobile application loading screen such as the color and loading screen images in “app loading screen” input areas 624 of FIG. 8.

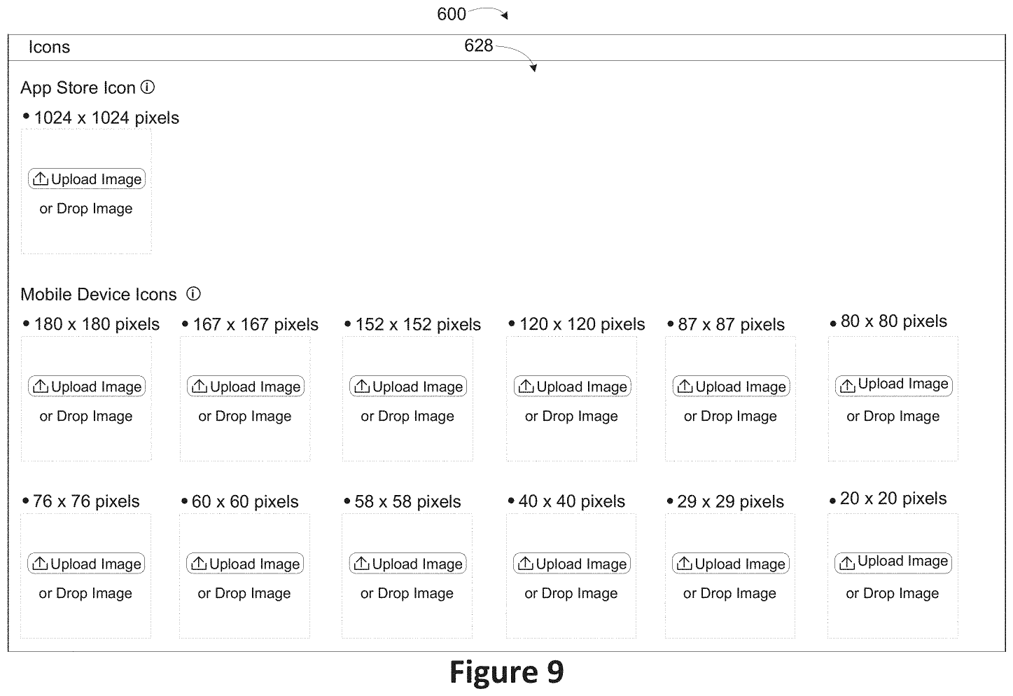

Also or alternatively, Catherine may choose the icons of the Wuthering Lights mobile application by uploading or dropping images of the icons in the “Icons” input areas 628 of FIG. 9.

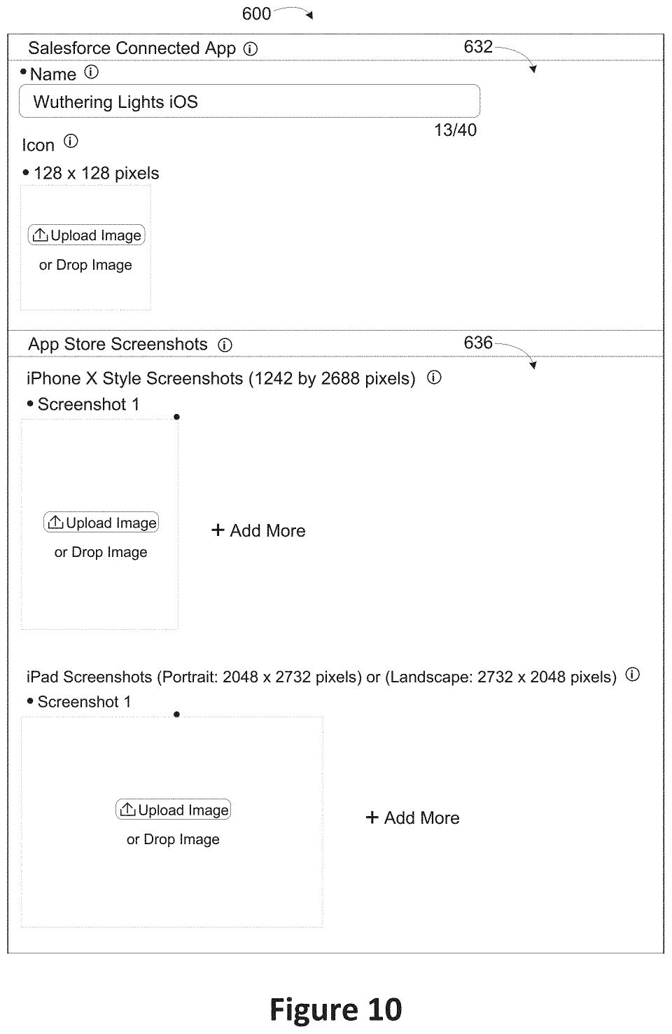

In some implementations, Catherine may enter “connected app” information in “Salesforce Connected App” input areas 632 of FIG. 10. As used herein, the term “connected app” refers to a framework that enables an external application to integrate with a computing platform such as Salesforce® using Application Programming Interfaces (APIs) and standard protocols. “Connected apps” may use these protocols to authenticate, authorize, and provide single sign-on (SSO) for external mobile applications such as the Wuthering Lights mobile application.

Also or alternatively, Catherine may choose the screenshots to be used in the Apple® App Store for the Wuthering Lights mobile application by uploading or dropping images of the screenshots in the “App Store Screenshots” input areas 636 of FIG. 10.

Continuing with the example depicted in FIGS. 6-11, Catherine may select the countries in which the Wuthering Lights mobile application is to be made available in Country Availability input area 640 of FIG. 11.

The way in which mobile applications are deployed may vary across implementations. As discussed above, in some implementations, distribution may be handled exclusively by an organization. On the other hand, the computing platform may provide automated distribution of mobile applications. By way of example, by selecting mobile applications “customer delegated public” in “distribution type” selection area 644 of FIG. 11, a mobile application may be published to an external application provider without making it known to customers of the mobile application provider that the mobile application was produced using the computing platform. Alternatively, an organization may want a mobile application to be provided to a mobile application provider such that the mobile application is indicated as being associated with the account of a computing platform (rather than the account of the organization) when the mobile application is provided to customers of the mobile application provider. In this case, “managed private” may be selected as the distribution type in the distribution type selection area 644 of FIG. 11. A detailed description of techniques for deploying mobile applications in a variety of manners is discussed in commonly assigned U.S. patent application Ser. No. 16/688,558, titled DEPLOYING MOBILE APPLICATIONS, by Brak et. al, filed on Ser. No. 16/688,558, and hereby incorporated by reference in its entirety and for all purposes.

Returning to FIG. 4, at 412, a request may be processed. The request may be received from the user via the user interface of the mobile application development environment 200 of FIG. 2 to publish a mobile application to a test environment associated with the computing platform 208 via a test channel associated with an application provider. By way of example, once she finishes entering the metadata to define the Wuthering Lights mobile application, Catherine may click or tap submit button 648 of FIG. 6. By clicking or tapping the submit button 648, Catherine may request for the Wuthering Lights mobile application to be produced and provided to the Apple® App Store as described above in the context of FIG. 2. As discussed above, Catherine may have designated a particular test environment (e.g., in in input area 608 of FIG. 6) in which the Wuthering Lights mobile application may be tested via TestFlight.

In some implementations, at 416 of FIG. 4, the mobile application may be automatically rejected. For instance, the mobile application development module 212 of FIG. 2 may process metadata entered by users requesting production of mobile applications and determine whether the metadata violates any of the rules of the mobile application provider(s) 216. Any time that the mobile application development module 212 identifies that metadata of a prospective mobile application violates a rule of a particular mobile application provider 216; the mobile application development module 212 may automatically reject the prospective mobile application. By way of example, when defining the new Wuthering Lights mobile application, Catherine makes a typo when entering the privacy policy Uniform Resource Locator (URL). As such, the URL she enters is invalid. The mobile application development module 212 may process the text Catherine entered as the privacy policy URL and determine that the privacy policy URL as entered by Catherine is invalid. The Apple® App store to which Catherine wishes to publish the new Wuthering Lights mobile application has a rule that requires a valid privacy policy URL. Accordingly, the mobile application development module 212 may automatically reject the new Wuthering Lights mobile application.

In some implementations, at 420 of FIG. 4, a communication may be sent. For instance, the communication may be automatically sent in response a mobile application being rejected at 416 of FIG. 4. The communication may include a detailed description of reasons for rejecting the mobile application. By way of illustration, returning to the above example, the mobile application development module 212 may send Catherine an automated email or text message explaining that the Apple® App store has a rule requiring a valid privacy policy URL and that the new Wuthering Lights mobile application has been rejected because the privacy policy URL as entered by Catherine is invalid.

At 424 of FIG. 4, a version of the mobile application may be produced. By way of example, in response to Catherine clicking or tapping submit button 648 of FIG. 6, the mobile application development module 212 may produce a beta version of the Wuthering Lights mobile application. As discussed above, the Wuthering Lights mobile application may be produced based on the metadata entered by Catherine in the mobile application metadata entry screen 600 of FIGS. 6-11.

At 428 of FIG. 4, the version of the mobile application may be provided to the mobile application provider. By way of illustration, in response to the beta version of the Wuthering Lights mobile application being produced at 424 of FIG. 4, the mobile application development module 212 of FIG. 2 may provide the beta version of the Wuthering Lights mobile application to the Apple® App Store as described above in the context of FIG. 2. As discussed above, the version of the mobile application may be provided to the mobile application provider to be made accessible to customers of the mobile application provider in a particular test environment via a particular test channel. By way of example, Catherine designated a sandbox community in the input area 608 of FIG. 7. As such, the beta version of the Wuthering Lights mobile application may be made available (via TestFlight) in the sandbox community designated by Catherine.

Also or alternatively, the version of the mobile application may be changed. By way of illustration, once the beta version of the Wuthering Lights mobile application has been reviewed by beta testers, and Catherine has determined that the Wuthering Lights mobile application is ready to go, Catherine may submit a request to the mobile application development module 212 of FIG. 2 to make a final version of the Wuthering Lights mobile application widely available via the Apple® App Store via the distribution type chosen by Catherine. As such, the mobile application development module 212 may provide the final version of the Wuthering Lights mobile application to the Apple® App Store to be made available to customers of the Apple® App Store via the distribution type chosen by Catherine.

In some implementations, at 432 of FIG. 4, the mobile application may be updated. By way of example, the mobile application may be automatically updated in response to an update to the computing platform 208 of FIG. 2. By way of illustration, the CRM platform being used by Wuthering lights may enable a new type of configurable push notifications.

The new type of configurable push notifications may allow workflow-triggered push notifications. For instance, a range of user-configurable events may be assigned as triggers for the new type of push notifications. By way of example, Wuthering Lights may configure a push notification such that any conversion of a particular type of lead may trigger a push notification. When the new type of push notifications are introduced into the computing platform 208 of FIG. 2, the mobile application development module 212 may automatically produce a new version of the Wuthering Lights mobile application that includes enablement of the new type of push notifications. The mobile application development module 212 may automatically provide the new version of the Wuthering Lights mobile application to the Apple® App Store such that the new version of the Wuthering Lights mobile application may be made available to customers of the Apple® App Store via the distribution type chosen by Catherine.

Also or alternatively, a mobile application may be automatically updated in response to an update made by an organization. By way of example, Catherine may change the Wuthering Lights logo. In response to the Wuthering Lights logo being changed, the mobile application development module 212 of FIG. 2 may cause the Wuthering Lights mobile application to be automatically updated to include the new Wuthering Lights logo. By way of illustration, the mobile application development module 212 may automatically produce a new version of the Wuthering Lights mobile application that replaces the old logo with the new logo. The mobile application development module 212 may automatically provide the new version of the Wuthering Lights mobile application to the Apple® App Store such that the new version of the Wuthering Lights mobile application may be made available to customers of the Apple® App Store via the distribution type chosen by Catherine.

FIG. 12 shows a block diagram of an example of an environment 1210 that includes an on-demand database service configured in accordance with some implementations. Environment 1210 may include user systems 1212, network 1214, database system 1216, processor system 1217, application platform 1218, network interface 1220, tenant data storage 1222, tenant data 1223, system data storage 1224, system data 1225, program code 1226, process space 1228, User Interface (UI) 1230, Application Program Interface (API) 1232, PL/SOQL 1234, save routines 1236, application setup mechanism 1238, application servers 1250-1 through 1250-N, system process space 1252, tenant process spaces 1254, tenant management process space 1260, tenant storage space 1262, user storage 1264, and application metadata 1266. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 1216, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 18 may be a framework that allows the creation, management, and execution of applications in system 1216. Such applications may be developed by the database service provider or by users or third-party application developers accessing the service. Application platform 1218 includes an application setup mechanism 1238 that supports application developers' creation and management of applications, which may be saved as metadata into tenant data storage 1222 by save routines 1236 for execution by subscribers as one or more tenant process spaces 1254 managed by tenant management process 1260 for example. Invocations to such applications may be coded using PL/SOQL 1234 that provides a programming language style interface extension to API 1232. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 1266 for a subscriber making such an invocation. Such system processes may also manage execution of application metadata 1266 as an application in a virtual machine.

In some implementations, each application server 1250 may handle requests for any user associated with any organization. A load balancing function (e.g., an F5 Big-IP load balancer) may distribute requests to the application servers 1250 based on an algorithm such as least-connections, round robin, observed response time, etc. Each application server 1250 may be configured to communicate with tenant data storage 1222 and the tenant data 1223 therein, and system data storage 1224 and the system data 1225 therein to serve requests of user systems 1212. The tenant data 1223 may be divided into individual tenant storage spaces 1262, which can be either a physical arrangement and/or a logical arrangement of data. Within each tenant storage space 1262, user storage 1264 and application metadata 1266 may be similarly allocated for each user. For example, a copy of a user's most recently used (MRU) items might be stored to user storage 1264. Similarly, a copy of MRU items for an entire tenant organization may be stored to tenant storage space 1262. A UI 1230 provides a user interface and an API 1232 provides an application programming interface to system 1216 resident processes to users and/or developers at user systems 1212.

System 1216 may implement a web-based mobile application production and/or deployment system. For example, in some implementations, system 1216 may include application servers configured to implement and execute a variety of software applications. The application servers may be configured to provide related data, code, forms, web pages and other information to and from user systems 1212. Additionally, the application servers may be configured to store information to, and retrieve information from a database system. Such information may include related data, objects, and/or Webpage content. With a multi-tenant system, data for multiple tenants may be stored in the same physical database object in tenant data storage 1222, however, tenant data may be arranged in the storage medium(s) of tenant data storage 1222 so that data of one tenant is kept logically separate from that of other tenants. In such a scheme, one tenant may not access another tenant's data, unless such data is expressly shared.

Several elements in the system shown in FIG. 12 include conventional, well-known elements that are explained only briefly here. For example, user system 1212 may include processor system 1212A, memory system 1212B, input system 1212C, and output system 12 12D. A user system 1212 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 1212 to access, process and view information, pages and applications available from system 1216 over network 1214. Network 1214 may be any network or combination of networks of devices that communicate with one another, such as any one or any combination of a LAN (local area network), WAN (wide area network), wireless network, or other appropriate configuration.

The users of user systems 1212 may differ in their respective capacities, and the capacity of a particular user system 1212 to access information may be determined at least in part by “permissions” of the particular user system 1212. As discussed herein, permissions generally govern access to computing resources such as data objects, components, and other entities of a computing system, such as a mobile application production and/or deployment system, a social networking system, and/or a CRM database system. “Permission sets” generally refer to groups of permissions that may be assigned to users of such a computing environment. For instance, the assignments of users and permission sets may be stored in one or more databases of System 1216. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 1216 may provide on-demand database service to user systems 1212 using an MTS arrangement. By way of example, one tenant organization may be a company that employs a sales force where each salesperson uses system 1216 to manage their sales process. Thus, a user in such an organization may maintain contact data, leads data, customer follow-up data, performance data, goals and progress data, etc., all applicable to that user's personal sales process (e.g., in tenant data storage 1222). In this arrangement, a user may manage his or her sales efforts and cycles from a variety of devices, since relevant data and applications to interact with (e.g., access, view, modify, report, transmit, calculate, etc.) such data may be maintained and accessed by any user system 1212 having network access.

When implemented in an MTS arrangement, system 1216 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 1216 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 1216 may also maintain system-level data usable by multiple tenants or other data. Such system-level data may include industry reports, news, postings, and the like that are sharable between tenant organizations.

In some implementations, user systems 1212 may be client systems communicating with application servers 1250 to request and update system-level and tenant-level data from system 1216. By way of example, user systems 1212 may send one or more queries requesting data of a database maintained in tenant data storage 1222 and/or system data storage 1224. An application server 1250 of system 1216 may automatically generate one or more SQL statements (e.g., one or more SQL queries) that are designed to access the requested data. System data storage 1224 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

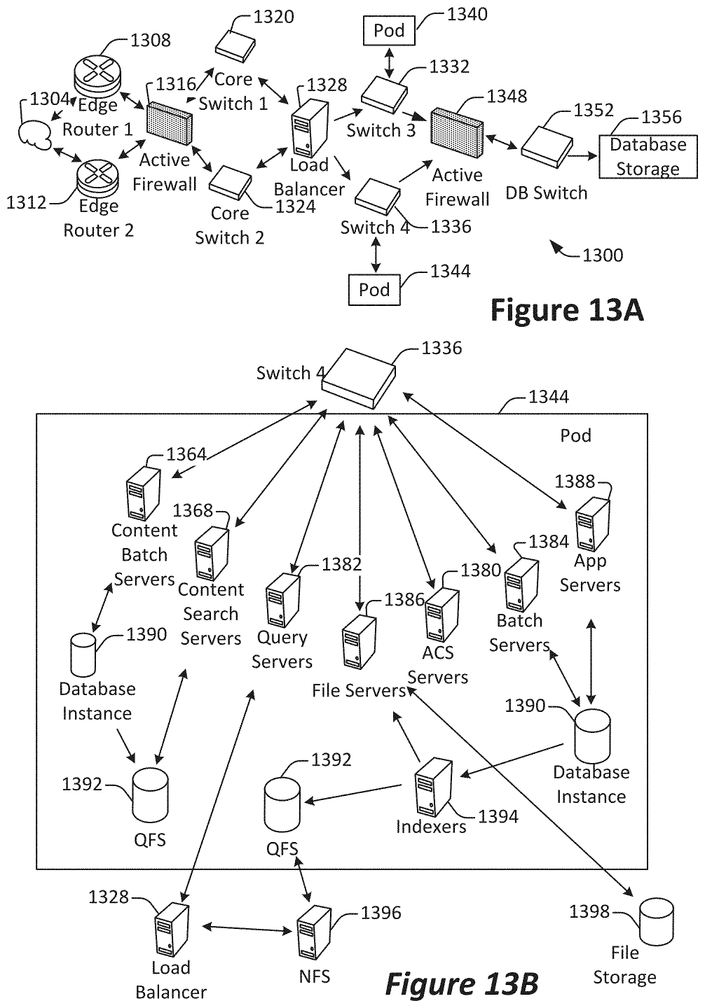

FIG. 13A shows a system diagram of an example of architectural components of an on-demand database service environment 1300, configured in accordance with some implementations. A client machine located in the cloud 1304 may communicate with the on-demand database service environment via one or more edge routers 1308 and 1312. A client machine may include any of the examples of user systems 1212 described above. The edge routers 1308 and 1312 may communicate with one or more core switches 1320 and 1324 via firewall 1316. The core switches may communicate with a load balancer 1328, which may distribute server load over different pods, such as the pods 1340 and 1344 by communication via pod switches 1332 and 1336. The pods 1340 and 1344, which may each include one or more servers and/or other computing resources, may perform data processing and other operations used to provide on-demand services. Components of the environment may communicate with a database storage 1356 via a database firewall 1348 and a database switch 1352.

Accessing an on-demand database service environment may involve communications transmitted among a variety of different components. The environment 1300 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 13A and 13B.

The cloud 1304 refers to any suitable data network or combination of data networks, which may include the Internet. Client machines located in the cloud 1304 may communicate with the on-demand database service environment 1300 to access services provided by the on-demand database service environment 1300. By way of example, client machines may access the on-demand database service environment 1300 to retrieve, store, edit, and/or process a variety of information.

In some implementations, the edge routers 1308 and 1312 route packets between the cloud 1304 and other components of the on-demand database service environment 1300. The edge routers 1308 and 1312 may employ the Border Gateway Protocol (BGP). The edge routers 1308 and 1312 may maintain a table of IP networks or ‘prefixes’, which designate network reachability among autonomous systems on the internet.

In one or more implementations, the firewall 1316 may protect the inner components of the environment 1300 from internet traffic. The firewall 1316 may block, permit, or deny access to the inner components of the on-demand database service environment 1300 based upon a set of rules and/or other criteria. The firewall 1316 may act as one or more of a packet filter, an application gateway, a stateful filter, a proxy server, or any other type of firewall.

In some implementations, the core switches 1320 and 1324 may be high-capacity switches that transfer packets within the environment 1300. The core switches 1320 and 1324 may be configured as network bridges that quickly route data between different components within the on-demand database service environment. The use of two or more core switches 1320 and 1324 may provide redundancy and/or reduced latency.

In some implementations, communication between the pods 1340 and 1344 may be conducted via the pod switches 1332 and 1336. The pod switches 1332 and 1336 may facilitate communication between the pods 1340 and 1344 and client machines, for example via core switches 1320 and 1324. Also or alternatively, the pod switches 1332 and 1336 may facilitate communication between the pods 1340 and 1344 and the database storage 1356. The load balancer 1328 may distribute workload between the pods, which may assist in improving the use of resources, increasing throughput, reducing response times, and/or reducing overhead. The load balancer 1328 may include multilayer switches to analyze and forward traffic.

In some implementations, access to the database storage 1356 may be guarded by a database firewall 1348, which may act as a computer application firewall operating at the database application layer of a protocol stack. The database firewall 1348 may protect the database storage 1356 from application attacks such as structure query language (SQL) injection, database rootkits, and unauthorized information disclosure. The database firewall 1348 may include a host using one or more forms of reverse proxy services to proxy traffic before passing it to a gateway router and/or may inspect the contents of database traffic and block certain content or database requests. The database firewall 1348 may work on the SQL application level atop the TCP/IP stack, managing applications' connection to the database or SQL management interfaces as well as intercepting and enforcing packets traveling to or from a database network or application interface.

In some implementations, the database storage 1356 may be an on-demand database system shared by many different organizations. The on-demand database service may employ a single-tenant approach, a multi-tenant approach, a virtualized approach, or any other type of database approach. Communication with the database storage 1356 may be conducted via the database switch 1352. The database storage 1356 may include various software components for handling database queries. Accordingly, the database switch 1352 may direct database queries transmitted by other components of the environment (e.g., the pods 1340 and 1344) to the correct components within the database storage 1356.

FIG. 13B shows a system diagram further illustrating an example of architectural components of an on-demand database service environment, in accordance with some implementations. The pod 1344 may be used to render services to user(s) of the on-demand database service environment 1300. The pod 1344 may include one or more content batch servers 1364, content search servers 1368, query servers 1382, file servers 1386, access control system (ACS) servers 1380, batch servers 1384, and app servers 1388. Also, the pod 1344 may include database instances 1390, quick file systems (QFS) 1392, and indexers 1394. Some or all communication between the servers in the pod 1344 may be transmitted via the switch 1336.

In some implementations, the app servers 1388 may include a framework dedicated to the execution of procedures (e.g., programs, routines, scripts) for supporting the construction of applications provided by the on-demand database service environment 1300 via the pod 1344. One or more instances of the app server 1388 may be configured to execute all or a portion of the operations of the services described herein.

In some implementations, as discussed above, the pod 1344 may include one or more database instances 1390. A database instance 1390 may be configured as an MTS in which different organizations share access to the same database, using the techniques described above. Database information may be transmitted to the indexer 1394, which may provide an index of information available in the database 1390 to file servers 1386. The QFS 1392 or other suitable filesystem may serve as a rapid-access file system for storing and accessing information available within the pod 1344. The QFS 1392 may support volume management capabilities, allowing many disks to be grouped together into a file system. The QFS 1392 may communicate with the database instances 1390, content search servers 1368 and/or indexers 1394 to identify, retrieve, move, and/or update data stored in the network file systems (NFS) 1396 and/or other storage systems.

In some implementations, one or more query servers 1382 may communicate with the NFS 1396 to retrieve and/or update information stored outside of the pod 1344. The NFS 1396 may allow servers located in the pod 1344 to access information over a network in a manner similar to how local storage is accessed. Queries from the query servers 1322 may be transmitted to the NFS 1396 via the load balancer 1328, which may distribute resource requests over various resources available in the on-demand database service environment 1300. The NFS 1396 may also communicate with the QFS 1392 to update the information stored on the NFS 1396 and/or to provide information to the QFS 1392 for use by servers located within the pod 1344.

In some implementations, the content batch servers 1364 may handle requests internal to the pod 1344. These requests may be long-running and/or not tied to a particular customer, such as requests related to log mining, cleanup work, and maintenance tasks. The content search servers 1368 may provide query and indexer functions such as functions allowing users to search through content stored in the on-demand database service environment 1300. The file servers 1386 may manage requests for information stored in the file storage 1398, which may store information such as documents, images, basic large objects (BLOBs), etc. The query servers 1382 may be used to retrieve information from one or more file systems. For example, the query system 1382 may receive requests for information from the app servers 1388 and then transmit information queries to the NFS 1396 located outside the pod 1344. The ACS servers 1380 may control access to data, hardware resources, or software resources called upon to render services provided by the pod 1344. The batch servers 1384 may process batch jobs, which are used to run tasks at specified times. Thus, the batch servers 1384 may transmit instructions to other servers, such as the app servers 1388, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

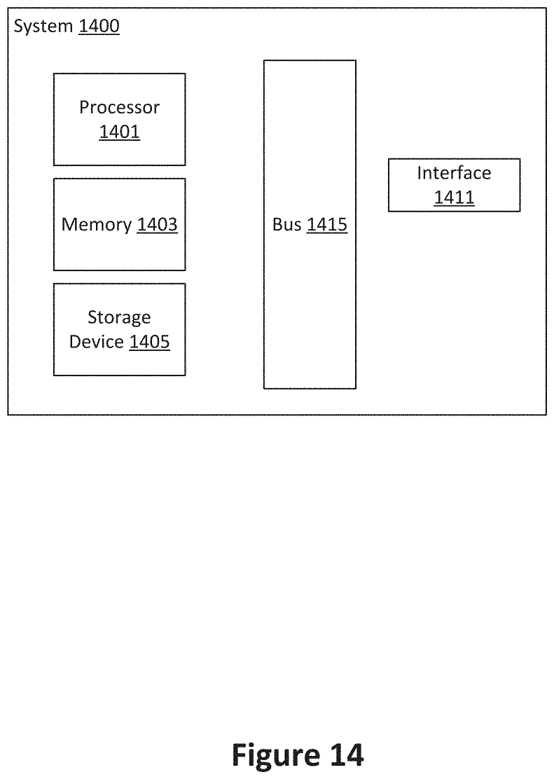

FIG. 14 illustrates one example of a computing device. According to various embodiments, a system 1400 suitable for implementing embodiments described herein includes a processor 1401, a memory module 1403, a storage device 1405, an interface 1411, and a bus 1415 (e.g., a PCI bus or other interconnection fabric.) System 1400 may operate as variety of devices such as an application server, a database server, or any other device or service described herein. Although a particular configuration is described, a variety of alternative configurations are possible. The processor 1401 may perform operations such as those described herein. Instructions for performing such operations may be embodied in the memory 1403, on one or more non-transitory computer readable media, or on some other storage device. Various specially configured devices can also be used in place of or in addition to the processor 1401. The interface 1411 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques of disclosed herein apply to a wide variety of computing environments. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A computing system implemented by a server system, the computing system being configurable to cause:
maintaining a mobile application development environment associated with a computing platform, the mobile application development environment configurable to produce mobile applications based on information provided by users of the computing platform;
displaying, on a device of a user of the computing platform, a user interface associated with the mobile application development environment;
processing a request, received from the user via the user interface, to produce a binary of a first mobile application; and
automatically producing, responsive to processing the request, the binary of the first mobile application.

2. The computing system of claim 1, wherein the computing platform is provided to a plurality of organizations via an on-demand computing environment, the user being affiliated with a first one of the organizations.

3. The computing system of claim 2, wherein the first mobile application is configurable to be distributed by the first organization to one or more mobile application providers.

4. The computing system of claim 3, wherein aspects associated with the first mobile application are configurable to be modified by the first organization, without interaction between the first organization and the computing platform, to be brought into compliance with rules of the one or more mobile application providers.

5. The computing system of claim 2, the computing system being further configurable to cause:
automatically distributing, to one or more mobile application providers, the first mobile application in accordance with organizational preferences of the first organization.

6. The computing system of claim 5, wherein the first mobile application is distributed to the mobile application providers such that the mobile application is indicated as being associated with an account of the first organization when the mobile application is provided to customers of the mobile application providers.

7. The computing system of claim 2, wherein the computing platform comprises a customer relationship management (CRM) platform and the binary of the first mobile application is produced based on a customizable branded space associated with the first organization, the customizable branded space being hosted by the CRM platform.

8. A method comprising:
maintaining a mobile application development environment associated with a computing platform, the mobile application development environment configurable to produce mobile applications based on information provided by users of the computing platform;
displaying, on a device of a user of the computing platform, a user interface associated with the mobile application development environment;
processing a request, received from the user via the user interface, to produce a binary of a first mobile application; and
automatically producing, responsive to processing the request, the binary of the first mobile application.

9. The method of claim 8, wherein the computing platform is provided to a plurality of organizations via an on-demand computing environment, the user being affiliated with a first one of the organizations.

10. The method of claim 9, wherein the first mobile application is configurable to be distributed by the first organization to one or more mobile application providers.

11. The method of claim 10, wherein aspects associated with the first mobile application are configurable to be modified by the first organization, without interaction between the first organization and the computing platform, to be brought into compliance with rules of the one or more mobile application providers.

12. The method of claim 9, the method further comprising:
automatically distributing, to one or more mobile application providers, the first mobile application in accordance with organizational preferences of the first organization.

13. The method of claim 12, wherein the first mobile application is distributed to the mobile application providers such that the mobile application is indicated as being associated with an account of the first organization when the mobile application is provided to customers of the mobile application providers.

14. The method of claim 9, wherein the computing platform comprises a customer relationship management (CRM) platform and the binary of the first mobile application is produced based on a customizable branded space associated with the first organization, the customizable branded space being hosted by the CRM platform.

15. A computer program product comprising computer-readable program code capable of being executed by one or more processors when retrieved from a non-transitory computer-readable medium, the program code comprising instructions configurable to cause:
maintaining a mobile application development environment associated with a computing platform, the mobile application development environment configurable to produce mobile applications based on information provided by users of the computing platform;
displaying, on a device of a user of the computing platform, a user interface associated with the mobile application development environment;
processing a request, received from the user via the user interface, to produce a binary of a first mobile application; and
automatically producing, responsive to processing the request, the binary of the first mobile application.

16. The computer program product of claim 15, wherein the computing platform is provided to a plurality of organizations via an on-demand computing environment, the user being affiliated with a first one of the organizations.

17. The computer program product of claim 16, wherein aspects associated with the first mobile application are configurable to be distributed by the first organization to one or more mobile application providers.

18. The computer program product of claim 17, wherein the first mobile application is configurable to be modified by the first organization, without interaction between the first organization and the computing platform, to be brought into compliance with rules of the one or more mobile application providers.

19. The computer program product of claim 16, the instructions being further configurable to cause:
automatically distributing, to one or more mobile application providers, the first mobile application in accordance with organizational preferences of the first organization.

20. The computer program product of claim 19, wherein the first mobile application is distributed to the mobile application providers such that the mobile application is indicated as being associated with an account of the first organization when the mobile application is provided to customers of the mobile application providers.
